(19) United States
(12) Patent Application Publication
(10) Pub. No.: US 2026/0155520 A1
(43) Pub. Date: Jun. 4, 2026

(54) BATTERY MODULE AND METHOD OF MANUFACTURING BATTERY MODULE

(71) Applicant: Samsung SDI Co., Ltd., Yongin-si (KR)

(72) Inventor: Seungbum KIM, Yongin-si (KR)

(21) Appl. No.: 19/354,101

(22) Filed: Oct. 9, 2025

(30) Foreign Application Priority Data
Oct. 14, 2024 (KR) 10-2024-0139887

(51) Int. Cl. H01M 50/262; H01M 50/209; H01M 50/242

(52) U.S. Cl. CPC H01M 50/262; H01M 50/209; H01M 50/242

(57) ABSTRACT

A battery module includes: a plurality of secondary cells; a bus bar connecting the plurality of secondary cells; a side plate fixing one side of the plurality of secondary cells; and end plates connected to outermost ones of the plurality of secondary cells at respective ends of the plurality of secondary cells. Each of the end plates includes: a first end plate; a second end plate; and a spring connected between the first end plate and the second end plate.

### CROSS-REFERENCE TO RELATED APPLICATION

The present application claims priority to and the benefit of Korean Patent Application No. 10-2024-0139887, filed on Oct. 14, 2024, in the Korean Intellectual Property Office, the entire disclosure of which is incorporated herein by reference.

### BACKGROUND

### 1. Field

Aspects of embodiments of the present disclosure relate to a battery module and a method of manufacturing a battery module.

### 2. Description of the Related Art

Different from primary batteries, which are not designed to be (re)charged, secondary batteries are designed to be discharged and recharged. Low-capacity secondary batteries are used in small, portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly including (or consisting of) a positive electrode and a negative electrode, a case that accommodates the electrode assembly, a terminal part connected to the electrode assembly, etc.

Lifespan tests of a conventional battery module include repeated charging and discharging tests. A swelling force, which occurs when a cell swells, is generated as the cell within the battery module is charged. Cells within the battery module generate a swelling force, and the swelling is transferred to cells at the outermost parts of the battery module.

In this case, a concentrated load is applied to a part of a cell that locally contacts a portion of the outermost structure of the battery module, and the capacity of the cell drops. To reduce a local concentrated load attributable to such a swelling force of the cell, the swelling force is reduced by forming a larger space between the cells. However, in this case, the length of the battery module is increased.

The above information disclosed in this Background section is for enhancement of understanding of the background of the present disclosure, and therefore, it may contain information that does not constitute related (or prior) art.

### SUMMARY

Embodiments of the present disclosure are directed a battery module including a bolt, a nut, and a spring between end plates of the battery module to reduce a cell swelling force and a method of manufacturing a battery module.

However, aspects and features of the present disclosure are not limited to those described above, and other aspects and feature not mentioned herein, will be clearly understood by those skilled in the art from the description of the present disclosure below.

A battery module, according to an embodiment of the present disclosure, includes a plurality of secondary cells that, a bus bar connecting the plurality of secondary cells, a side plate fixing one side of the plurality of secondary cells, and end plates connected to outermost ones of the secondary cells at both ends of the plurality of secondary cells. Each of the end plates includes a first end plate, a second end plate, and a spring connected between the first end plate and the second end plate.

In embodiments, a distance between the first end plate and second end plate of the end plate may vary in response to a change in a length of the spring.

In embodiments, the end plate may include five or more of the springs at the center of the end plate and at corners of the end plate.

In embodiments, the spring may be a volute spring.

In embodiments, the first end plate and second end plate of the end plate may be connected through a nut and bolt structure.

In embodiments, the second end plate may have a nut to be coupled to the bolt formed therein. The second end plate may be coupled and fixed by the bolts.

In embodiments, the first end plate may have a through hole through which the bolt passes. The second end plate may move as the bolt moves along the through hole.

In embodiments, the bolt may include a plurality of bolts spaced apart from a center of the end plate.

In embodiments, the first end plate may include pillars at both sides of a surface thereof facing the second end plate.

In embodiments, a hole may be formed at the top of the pillars.

In embodiments, each of the secondary cells may be a prismatic secondary battery.

A method of manufacturing a battery module, according to an embodiment of the present disclosure, includes providing a plurality of secondary cells, connecting the plurality of secondary cells through a bus bar, fixing one side of the plurality of secondary cells through a side plate, and connecting outermost ones of the secondary cells at both ends of the plurality of secondary cells and end plates by providing a first end plate and a second end plate and connecting the first end plate and the second end plate by a spring between the first end plate and the second end plate.

In embodiments, the method may further include constructing the first end plate and the second end plate so that a distance between the first end plate and the second end plate varies in response to a change in a length of the spring.

In embodiments, the connecting of the first end plate and the second end plate may include providing a plurality of springs at a center of the end plate and at corners of the end plate.

In embodiments, the connecting of the first end plate and the second end plate may include coupling the first end plate and the second end plate through one a nut and bolt structure.

In embodiments, the coupling of the first end plate and the second end plate through the nut and bolt structure may include forming a nut to be coupled to a bolt in the second end plate and coupling and fixing the second end plate by the bolt.

In embodiments, the coupling of the first end plate and the second end plate through the nut and bolt structure may include forming a through hole through which the bolt passes in the first end plate and constructing the second end plate so that the second end plate moves as the bolt moves along the through hole.

In embodiments, the coupling of the first end plate and the second end plate through the nut and bolt structure may include providing a plurality of bolts spaced apart from a center of the end plate.

In embodiments, the method may further include forming pillars on both sides of a surface of the first end plate that faces the second end plate.

In embodiments, the method may further include forming a hole at the top of the pillars.

Embodiments of the present disclosure avoid a capacity drop phenomenon by preventing lithium plating of a cell at an end of a battery module attributable to a locally concentrated load because the end plates of the battery module reduce the length of the battery module upon charging and increase the length of the battery module upon discharging when a concentrated load of a swelling force is applied at both ends of the battery module without a change in the length of the battery module, and thus, the lifespan of the battery module is improved.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure and further explain and describe the technical spirit of the present disclosure along with the aforementioned content of the disclosure. Accordingly, the present disclosure should not be construed as being limited to the contents described in the drawings, in which:

FIG. 1A is an upper perspective view of a prismatic secondary battery.

FIG. 1B is a cross-sectional view taken along the line I-I in FIG. 1A.

FIGS. 2A and 2B are diagrams illustrating a conventional battery module.

FIG. 3 is a cross-sectional view of a conventional battery module taken in the direction X of FIG. 2 to illustrate a swelling force of the conventional battery module.

FIG. 4A is a coupling view of end plates of a battery module according to embodiments of the present disclosure.

FIG. 4B is an exploded view of the end plates of the battery module shown in FIG. 4A.

FIG. 5 is a diagram illustrating a volute spring which may be used in the end plate of the battery module according to embodiments of the present disclosure.

FIG. 6A is a perspective view of a battery module according to embodiments of the present disclosure.

FIG. 6B is a partial view of the battery module shown in FIG. 6A.

FIG. 7 is a flowchart describing a method of manufacturing a battery module according to embodiments of the present disclosure.

### DETAILED DESCRIPTION

Embodiments of the present disclosure will be described below, in detail, with reference to the accompanying drawings. Prior to the description, it is noted that the terms or words used in this specification and claims should not be construed as being limited to their common or dictionary meanings but instead should be understood to have meanings and concepts in agreement with the spirit of the present disclosure based on the principle that an inventor can define the concept of each term suitably in order to describe his/her own invention in the best way possible. Moreover, the embodiments described in this specification and the configurations illustrated in the drawings are only some examples of the present disclosure and do not cover all the technical ideas of the present disclosure; thus, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of about 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

The present disclosure will be described, in detail, with reference to the attached drawings.

Examples of secondary batteries include a coin type, a cylindrical type, a prismatic type, and a pouch type. The present disclosure is generally applicable to a prismatic secondary battery. Therefore, the prismatic secondary battery will first be briefly described prior to description of embodiments of the present disclosure. However, aspects and features of the present disclosure are applicable to other types of secondary batteries, and the present disclosure is not limited to prismatic secondary batteries.

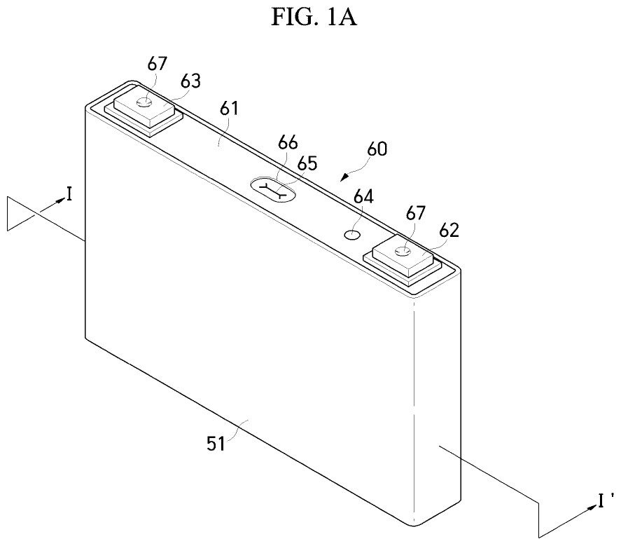

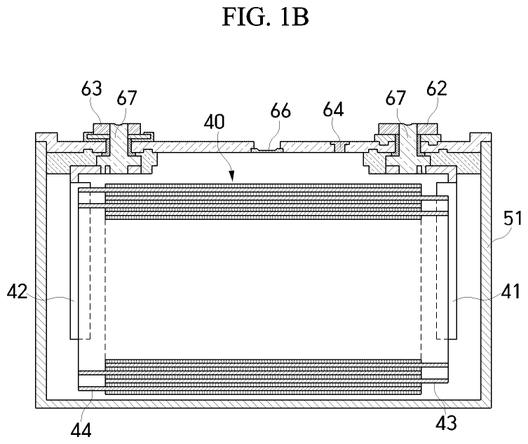

FIG. 1A is a top perspective view of the prismatic secondary battery. FIG. 1B is a cross-sectional view taken along the line I-I′ in FIG. 1A.

First, the external appearance of the prismatic secondary battery as illustrated in FIG. 1A will be described.

A casing 51 defines an overall appearance of the prismatic secondary battery and may be made of conductive metal, such as aluminum, an aluminum alloy, or nickel-plated steel. In addition, the casing 51 may provide (or may form) a space for accommodating an electrode assembly therein.

A cap assembly 60 may include a cap plate 61 that covers an opening in the casing 51, and the cap assembly 60 and the cap plate 61 may be made of a conductive material. A first terminal 62 and a second terminal 63 may be electrically connected to positive and negative (or negative and positive) electrodes, respectively, inside the casing 51 and may be installed to protrude outwardly through the cap plate 61.

The cap plate 61 may have an electrolyte injection port 64 with a sealing plug installed therein and a vent 66 having a notch 65. The vent 66 is for degassing the secondary battery, that is, for discharging excess gas generated inside the secondary battery.

With reference to FIG. 1B, the internal structure of the prismatic secondary battery and the coupling structure with the cap assembly 60 will be described.

As illustrated in FIG. 1B, the prismatic secondary battery generally includes an electrode assembly 40, a first current collector part 41, a first terminal 62, the second current collector part 42, the second terminal 63, and the cap assembly 60.

The electrode assembly 40 may be formed by winding or stacking a laminate of a first electrode plate, a separator, and a second electrode plate, each of which are in the form of a plate or a film. When the electrode assembly 40 is a wound laminate, it may have a winding axis that is parallel to a longitudinal direction of the casing 51. The electrode assembly 40 may be of a stack type rather than a winding type, but the shape of the electrode assembly 40 is not limited in the present disclosure. In addition, the electrode assembly 40 may be a Z-stack electrode assembly in which a first electrode plate and a second electrode plate are inserted into both sides (e.g., opposite sides) of a separator that is then bent (or folded) into a Z-stack. Furthermore, the electrode assembly 40 may consist of one or more electrode assemblies, which are stacked such that their long sides are adjacent to each other and accommodated in the casing 51, and the number of electrode assemblies is not limited in the present disclosure. The electrode assembly 40 may include a first electrode plate that acts as a negative electrode and a second electrode plate that acts as a positive electrode, or vice versa.

The first electrode plate may be formed by applying a first electrode active material, such as graphite or carbon, to a first electrode current collector plate made of a metal foil, such as copper, a copper alloy, nickel, or a nickel alloy. The first electrode plate may include a first electrode tab (e.g., a first uncoated part) 43, which is a region at where the first electrode active material is not present. The first electrode tab 43 may act as a current flow passage between the first electrode plate and the first current collector part 41. In some embodiments, the first electrode tab 43 may be formed by cutting the first electrode plate to protrude to one side in advance when manufacturing the first electrode plate, or may protrude further to one side than (e.g., may protrude beyond) the separator without separate cutting.

The second electrode plate may be formed by applying a second electrode active material such as transition metal oxide to a substrate made of metal foil, such as aluminum or aluminum alloy. The second electrode plate may include a second electrode tab (or second uncoated part) 44, which is a region without application of the second electrode active material. The second electrode tab 44 may act as a current flow passage between the second electrode plate and the second current collector part 42. In some examples, the second electrode tab 44 may be formed by cutting the second electrode plate to protrude to the other side in advance when manufacturing the second electrode plate, and may protrude further to the other side than the separator without separate cutting.

In some embodiments, the first electrode tab 43 may be located on the right end side of the electrode assembly 40, and the second electrode tab 44 may be located on the left end side of the electrode assembly 40. In another embodiment, the first electrode tab 43 and the second electrode tab 44 may be located on one end side of the electrode assembly 40 in the same direction. Here, the left and the right sides refer to the secondary battery illustrated in FIGS. 1A and 1B for convenience of explanation, and they may change in position when the secondary battery is rotated left and right or up and down.

The separator prevents a short circuit between the first electrode plate and the second electrode plate while permitting migration of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate extend from both ends (e.g., opposite ends) of the electrode assembly 40 as described above, respectively. In some embodiments, the electrode assembly 40 may be accommodated together with an electrolyte in the casing 51.

In the electrode assembly 40, the first current collector part 41 and the second current collector part 42 may be welded and connected to the first electrode tab 43 extending from the first electrode plate and the second electrode tab 44 extending from the second electrode plate, respectively.

The first current collector part 41 and the second current collector part 42 are connected to the first terminal 62 and the second terminal 63, as described with reference to FIG. 1A, through terminal pins 67, respectively. In some embodiments, the terminal pins 67 may each have an outer peripheral surface that is threaded and may be fastened to the first terminal 62 and the second terminal 63 by screwing. However, the present disclosure is not limited thereto. For example, the terminal pins 67 may also be coupled to the first terminal 62 and the second terminal 63 by riveting or welding.

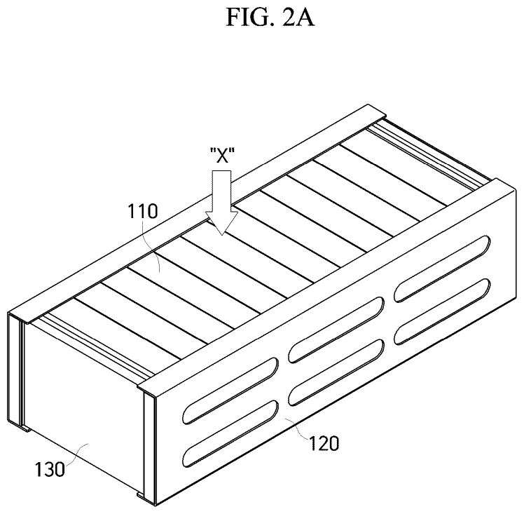

FIGS. 2A and 2B are diagrams illustrating a conventional battery module.

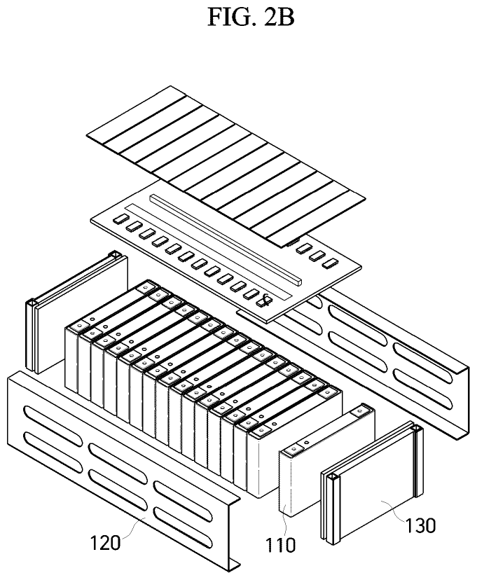

FIG. 3 is a cross-sectional view illustrating the conventional battery module viewed in the direction X of FIG. 2 to illustrate a swelling force of the conventional battery module.

Referring to FIGS. 2A, 2B, and 3, a conventional battery module may include a plurality of cells 110, side plates 120 that fix the top and bottom of the plurality of cells 110, and end plates 130 that contact both sides (e.g., opposite or outermost sides) of outermost ones of the plurality of cells 110.

FIG. 3 shows the conventional battery module in the direction X of FIG. 2 and is a view of the conventional battery module from above.

The plurality of cells 110 may be connected to through a bus bar 140. The end plate 130 may include fixing parts 150 for fixing (or coupling) to, for example, a vehicle.

Furthermore, the fixing part 150 may be (or may include) a plate bush (or plate bushing) and may be disposed to locally contact (e.g., to directly contact) an outermost cell 10 of the battery module.

In a conventional battery module, a lifespan test includes repeated charging and discharging tests. A force that results from a cell swelling toward both sides thereof, that is, a swelling force, as the cell within the battery module is charged, may be generated. Cells within the battery module may generate a swelling force, and thus, a swelling force that is most powerful (or is multiplied) may be transferred to the outermost cells of the battery module. In this case, a concentrated load may be applied to a part of a cell that locally contacts a portion of the outermost part structure of the battery module, and the capacity of the cell may drop. To reduce a local concentrated load attributable to such a swelling force of the cells, the swelling force may be reduced by increasing the distance between the cells to form a space. However, this increases the length of the battery module.

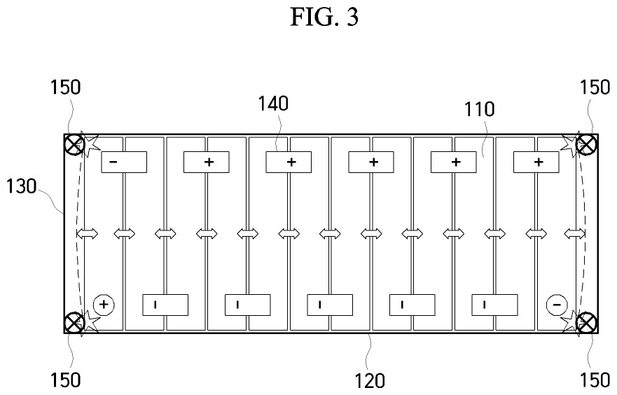

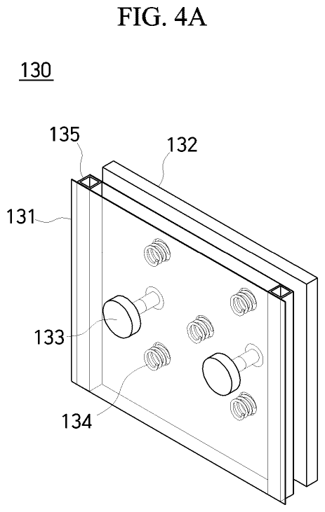

FIG. 4A is a coupling view of end plates of a battery module according to embodiments of the present disclosure. FIG. 4B is an exploded view of the end plates of the battery module shown in FIG. 4A.

Referring to FIGS. 4A and 4B, the end plate 130 of the battery module according to embodiments of the present disclosure may include a first end plate 131, that is, a front part (or a front plate), and a second end plate 132, that is, a rear part (or rear plate). The end plate 130 may include springs 134 between the first end plate 131 and the second end plate 132.

The first end plate 131 and the second end plate 132 may be coupled together through one or more nut and bolt structures. In embodiments, as illustrated in FIG. 4B, the second end plate 132 may have nuts (e.g., threaded openings) into which one or more bolts 133 are coupled therein and may be coupled and fixed by the one or more bolts 133. In such an embodiment, the first end plate 131 may have through holes through which the one or more bolts 133 penetrate (or extend therethrough). The second end plate 132 may be moved as the one or more bolts 133 are moved along the through holes. For example, the one or more bolts 133 may be moved along the through holes and, thus, may provide guidance to (e.g., may guide) the movement of the second end plate 132. If the swelling of the cell 110 occurs when the battery module is charged and discharged, the one or more bolts 133 may be moved along the through holes, the springs 134 may be compressed, and the second end plate 132 may be moved in the outside direction of the battery module. In embodiments, as illustrated in FIGS. 2A and 2B, the one or more bolts 133 may be two or more bolts that are spaced apart from the center of the end plate 130 at an interval (e.g., a predetermined interval) or greater. The two or more bolts 133 may be disposed at such locations and can effectively guide the movement of the second end plate 132.

The plurality of springs 134 may be included between the first end plate 131 and the second end plate 132. In embodiments, a distance between the first end plate 131 and the second end plate 132 may be changed (e.g., may vary) in response to a change in the length of the spring 134. In embodiments, the end plate 130 may include five or more springs 134 that are disposed at the center of the end plate 130 and the corners of the end plate 130. The five or more springs 134 may be disposed at such locations and can stably distribute a swelling force.

Pillars 135 may be formed on both sides of a surface of the first end plate 131 that faces the second end plate 132. The first end plate 131 may form a structure for supporting the battery module through the pillars 135 formed on both sides. Furthermore, a hole may be formed at the top of the pillar 135. The hole formed at the top of the pillar 135 may be used when the battery module is assembled.

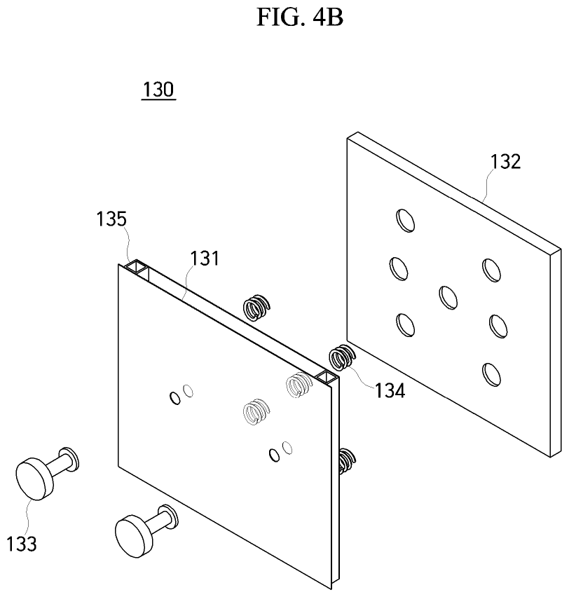

FIG. 5 is a diagram illustrating a volute spring, which may be used in the end plate of the battery module according to embodiments of the present disclosure.

Referring to FIG. 5, the spring 134 disposed at the center of the end plate 130 of the battery module according to embodiments of the present disclosure may be a volute spring (e.g., a conical spring). Generally, the swelling force of a cell may be applied to both ends of the battery module with pressure of about 30,000 N. To hold (or resist) the swelling force, the end plate 130 of the battery module according to embodiments of the present disclosure may be designed to distribute the swelling force by using the volute spring 134, that is, a compression spring that is formed by rolling up a steel plate having a rectangular cross section as a kind of conical coil spring at five or more locations (e.g., having five or more turns).

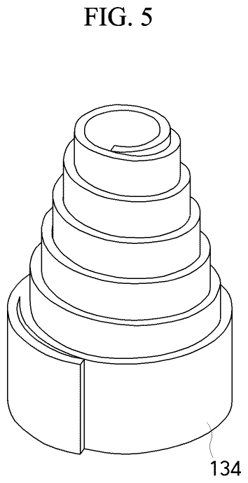

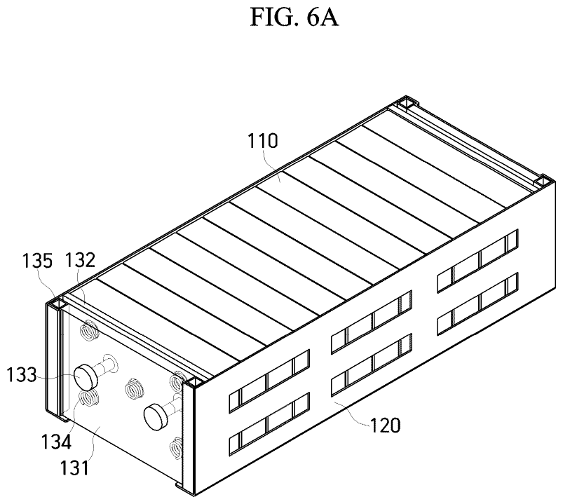

FIG. 6A is a perspective view of a battery module according to embodiments of the present disclosure. FIG. 6B is a partial side view of the battery module shown in FIG. 6A.

Referring to FIGS. 6A and 6B, the end plate 130 of the battery module according to embodiments of the present disclosure is connected to the outermost parts of the cells 110 (e.g., the outermost cells 110) at both ends of the battery module. FIG. 6B is a side view of the battery module according to embodiments of the present disclosure. If the cell 110 swells when the battery module is charged and discharged, the one or more bolts 133 may move along the through holes, the springs 134 may be compressed, and the second end plate 132 may be moved in the outside direction of the battery module. As described above, a deformation of the entire battery module can be prevented via the springs 134 acting between the first end plate 131 and the second end plate 132.

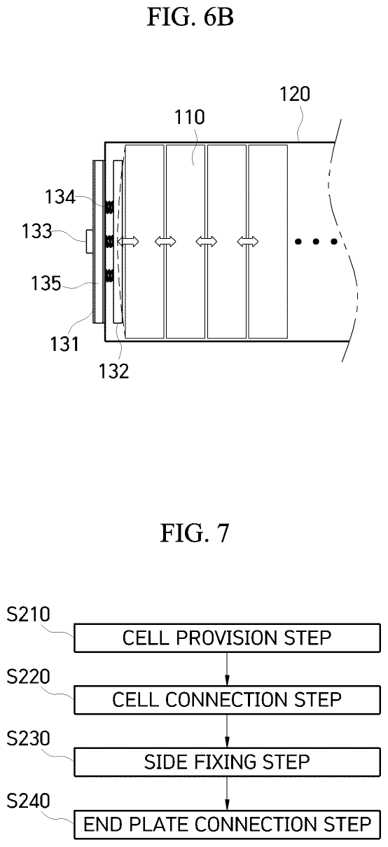

FIG. 7 is a flowchart describing a method of manufacturing a battery module according to embodiments of the present disclosure.

Referring to FIG. 7, the method of manufacturing a battery module according to embodiments of the present disclosure may include step S210 to step S240.

Step S210 is a cell provision step and may be a step of providing a plurality of cells that perform a charging or discharging function (e.g., secondary battery cells or secondary cells). In embodiments, the plurality of cells may be a plurality of prismatic secondary batteries.

Step S220 is a cell connection step and may be a step of connecting the plurality of cells through a bus bar.

Step S230 is a one side fixing step and may be a step of fixing one side of the plurality of cells through the side plate.

Step S240 is an end plate connection step and may be a step of connecting cells at both ends of the plurality of cells and the end plates. Step S240 may include a step of providing the first end plate and the second end plate and a step of connecting the first end plate and the second end plate, including the springs between the first end plate and the second end plate.

The method of manufacturing a battery module according to embodiments of the present disclosure has been described with reference to the flowcharts presented in the drawings. For a simple description, the method has been illustrated and described as a series of blocks, but the present disclosure is not limited to the sequence of the blocks, and some blocks may be performed in a sequence different from or concurrently (or simultaneously) with that of other blocks, which has been illustrated and described in this specification. Various other branches, flow paths, and sequences of blocks which achieve the same or similar results may be implemented. Furthermore, all the blocks illustrated to implement the method described in this specification may not be required.

In the description given with reference to FIG. 7, each of the steps may be further divided into additional steps or the steps may be coupled into smaller steps depending on an implementation example of the present disclosure. Furthermore, some of the steps may be omitted, if necessary, and the sequence of the steps may be changed. Furthermore, the contents of FIGS. 1A to 6B, although some contents are omitted, may be applied to the contents of FIG. 7. Furthermore, the contents of FIG. 7 may be applied to the contents of FIGS. 1A to 6B.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material. For example, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector. The positive electrode active material layer may include the positive electrode active material and may further include a binder and/or a conductive material.

Content of the positive electrode active material may be in a range of about 90 wt. % to about 99.5 wt. % with respect to the positive electrode active material layer 100 wt. %. Content of the binder and the conductive material may be in a range of about 0.5 wt. % to about 5 wt. % with respect to the positive electrode active material layer 100 wt. %.

Al may be used as the current collector, but the present disclosure is not limited thereto.

A negative electrode active material may include a material capable of reversibly Intercalation/de-intercalation with respect to lithium ions, lithium metal, an alloy of lithium metal, a material capable of doping and dedoping with respect to lithium, or transition metal oxide.

The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material and may further include a binder and/or a conductive material.

For example, the negative electrode active material layer may include the negative electrode active material in a range of about 90 wt. % to about 99 wt. %, the binder in a range of about 0.5 wt. % to about 5 wt. %, and the conductive material in a range of 0 wt. % to about 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning (or determining) viscosity.

One selected from among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may be a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer structure including two or more layers of them may be used as the separator.

The separator may include a porous base and a coating layer including an organic matter, an inorganic matter, or a combination of them that is disposed on one or both sides of the porous base.

The organic matter may include a polyvinylidene fluoride-based heavy antibody or (meth)acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

### DESCRIPTION OF SOME REFERENCE SYMBOLS

| | |
|---|---|
| 110: cell | 120: side plate |
| 130: end plate | 131: first end plate |
| 132: second end plate | 133: bolt |
| 134: spring | 135: pillar |
| 140: bus bar | 150: fixing part |

What is claimed is:

1. A battery module comprising:
a plurality of secondary cells;
a bus bar connecting the plurality of secondary cells;
a side plate fixing one side of the plurality of secondary cells; and
end plates connected to outermost ones of the plurality of secondary cells at respective ends of the plurality of secondary cells, each of the end plates comprising:
a first end plate;
a second end plate; and
a spring connected between the first end plate and the second end plate.

2. The battery module as claimed in claim 1, wherein a distance between the first end plate and second end plate of the end plate is configured to vary in response to a change in a length of the spring.

3. The battery module as claimed in claim 1, wherein the end plate comprises five or more of the springs, and
wherein the springs are arranged at a center of the end plate and at corners of the end plate.

4. The battery module as claimed in claim 1, wherein the spring is a volute spring.

5. The battery module as claimed in claim 1, wherein the first end plate and second end plate of the end plate are connected together via a nut and bolt structure.

6. The battery module as claimed in claim 5, wherein the second end plate comprises a nut formed therein, and
wherein the second end plate is coupled and fixed by a bolts screwed into the nut.

7. The battery module as claimed in claim 6, wherein the first end plate has a through hole formed therein, the bolts extending through the through hole, and
wherein the second end plate moves as the bolt moves along the through hole.

8. The battery module as claimed in claim 6, wherein the bolt comprises a plurality of bolts spaced apart from a center of the end plate.

9. The battery module as claimed in claim 1, wherein the first end plate comprises pillars on both sides of a surface thereof, the pillars configured to contact the second end plate.

10. The battery module as claimed in claim 9, wherein a hole is formed in a top of the pillars.

11. The battery module as claimed in claim 1, wherein each of the plurality of secondary cells is a prismatic secondary battery.

12. A method of manufacturing a battery module, the method comprising:
connecting a plurality of secondary cells via a bus bar;
fixing one side of the plurality of secondary cells through a side plate; and
connecting outermost ones of the plurality of secondary cells and end plates by:
providing a first end plate and a second end plate; and
arranging springs between the first end plate and the second end plate.

13. The method as claimed in claim 12, further comprising connecting the first end plate and the second end plate so that a distance between the first end plate and the second end plate varies in response to a change in a length of the springs.

14. The method as claimed in claim 12, wherein the connecting of the first end plate and the second end plate comprises providing five or more springs at a center of the end plate and corners of the end plate.

15. The method as claimed in claim 12, wherein the connecting the first end plate and the second end plate comprises coupling the first end plate and the second end plate through a nut and bolt structure.

16. The method as claimed in claim 15, wherein the coupling of the first end plate and the second end plate through the nut and bolt structures comprises:
forming a nut to be coupled with the bolt in the second end plate; and
coupling and fixing the second end plate with the bolt.

17. The method as claimed in claim 16, wherein the coupling of the first end plate and the second end plate through the nut and bolt structure comprises:
forming a through hole through which the bolt passes in the first end plate; and
constructing the second end plate so that the second end plate moves as the bolt moves along the through hole.

18. The method as claimed in claim 15, wherein the coupling of the first end plate and the second end plate through the nut and bolt structure comprises providing a plurality of bolts to be spaced apart from a center of the end plate.

19. The method as claimed in claim 12, wherein the providing of the first end plate and the second end plate comprises forming pillars on both sides of a surface of the first end plate that faces the second end plate.

20. The method as claimed in claim 19, wherein the providing of the first end plate and the second end plate further comprises forming a hole at a top of the pillars.
